(19) United States
(12) Patent Application Publication
(10) Pub. No.: US 2016/0176108 A1
(43) Pub. Date: Jun. 23, 2016

(54) 3D printer and scanner mechanisms

(71) Applicant: NEA 3D Inc., Toronto (CA)

(72) Inventors: Stoyan Tadin, Toronto (CA); William Chang, Toronto (CA); Sang Hoon Hwang, Mississauga (CA)

(21) Appl. No.: 14/757,657

(22) Filed: Dec. 23, 2015

Related U.S. Application Data
(60) Provisional application No. 62/096,335, filed on Dec. 23, 2014.

(51) Int. Cl. B29C 67/00

(52) U.S. Cl. CPC B29C 67/0055; B29C 67/0092; B33Y 30/00

(57) ABSTRACT

Various embodiments regarding systems and mechanisms for 3D printer and scanner devices. In accordance with an example embodiment, there is provided a print head assembly for a 3D printer which uses filament, including: a print head; a motor drive to control flow of the filament through the print head; and at least two idlers to provide traction between the motor drive gear and the filament.

### CROSS-REFERENCE

This application claims the benefit of the filing date of U.S. Provisional Patent Application Ser. No. 62/096,335 filed Dec. 23, 2014 entitled 3D PRINTER AND SCANNER MECHANISMS, the contents of which are hereby expressly incorporated by reference into the Detailed Description of the Drawings herein below.

### FIELD

The present application describes various embodiments regarding systems and mechanisms for 3D printer and scanner devices.

### BACKGROUND

It is desirable to reduce unwanted printer head movement. Unwanted printer head movement can result in parts with incorrect geometry and poor surface finish. Unwanted printer head movement reduces the accuracy of the printer.

Other difficulties with existing systems, methods and techniques may be appreciated in view of the Detailed Description of the Drawings herein below.

### BRIEF DESCRIPTION OF THE DRAWINGS

Embodiments will now be described by way of examples with reference to the accompanying drawings, in which like reference numerals are used to indicate similar features, and in which:

FIG. 1a shows an isometric view of 3D printer 1.

FIG. 1b shows front view of 3D printer 1.

FIG. 1c shows a detail view from FIG. 1b.

FIG. 2 shows a front view of prior art filament motor drive.

FIG. 3 is a section view from FIG. 1b.

FIG. 4 is a detail view from FIG. 1b.

FIG. 5a is an isometric view of 3D printer 1 showing roller bearings 27 with some components hidden.

FIG. 5b is a front view of the assembly shown in FIG. 5a.

FIG. 5c is a section from FIG. 5b.

FIG. 6a is an isometric view of 3D printer 1 with some components hidden.

FIG. 6b is a front view of 3D printer 1 shown in FIG. 6a.

FIG. 6c is a side view of 3D printer 1 shown in FIG. 6a.

FIG. 7a is an isometric view of the assembly shown in FIG. 6a with XZ axis assembly 43 disengaged from elevator brackets 55.

FIG. 7b is a detail view from FIG. 7a.

FIG. 8a is a rear top isometric view of XZ axis assembly 43 with some components hidden.

FIG. 8b is a rear bottom isometric view of the assembly shown in FIG. 8a.

FIG. 8c is a bottom view of XZ axis assembly 43.

FIG. 9a is a rear top isometric view of XZ axis assembly 43 with plates hidden.

FIG. 9b is a rear view of the assembly shown in FIG. 9a.

FIG. 9c is a section view from FIG. 9b.

FIG. 10a is a rear isometric view of 3D printer 1 with the spool and spool tray hidden.

FIG. 10b is a detail view from FIG. 10a.

FIG. 10c is a top view of 3D printer 1 shown in FIG. 10a.

### DETAILED DESCRIPTION OF THE INVENTION

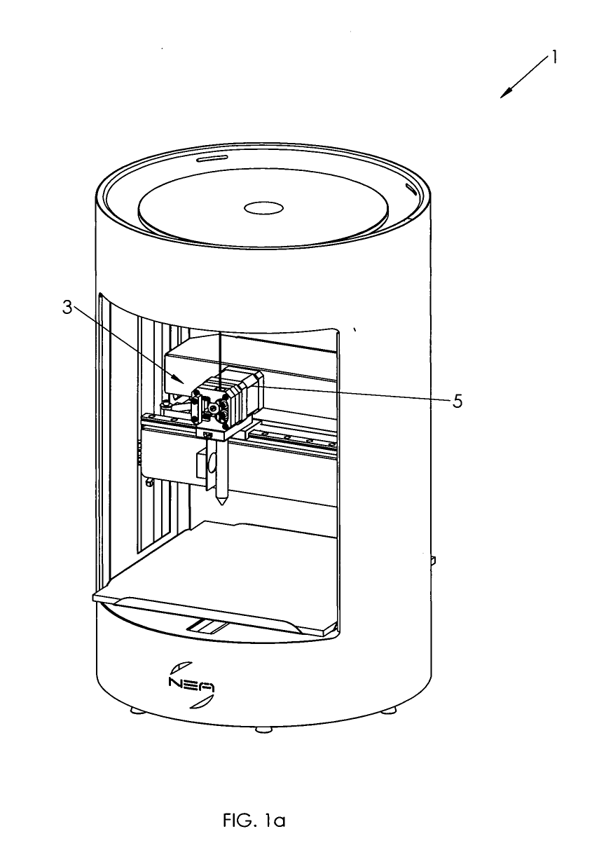

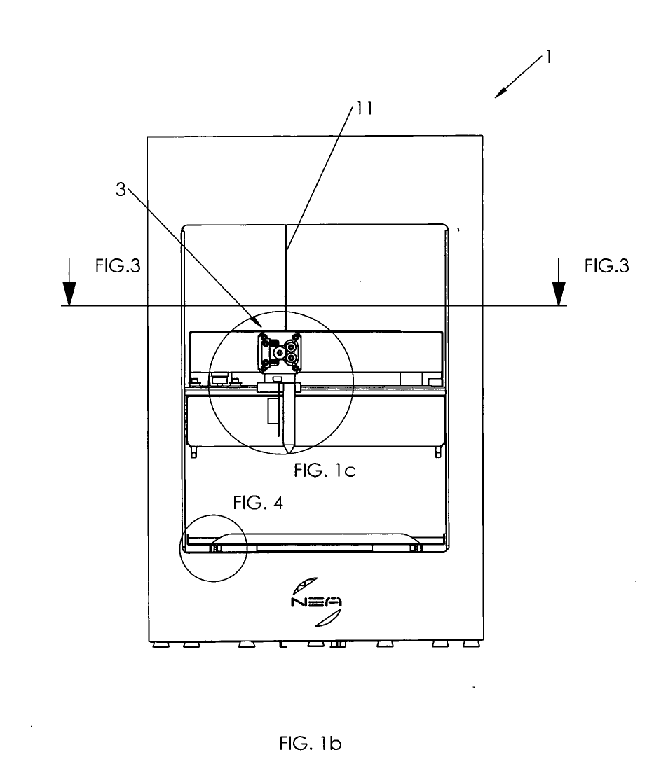

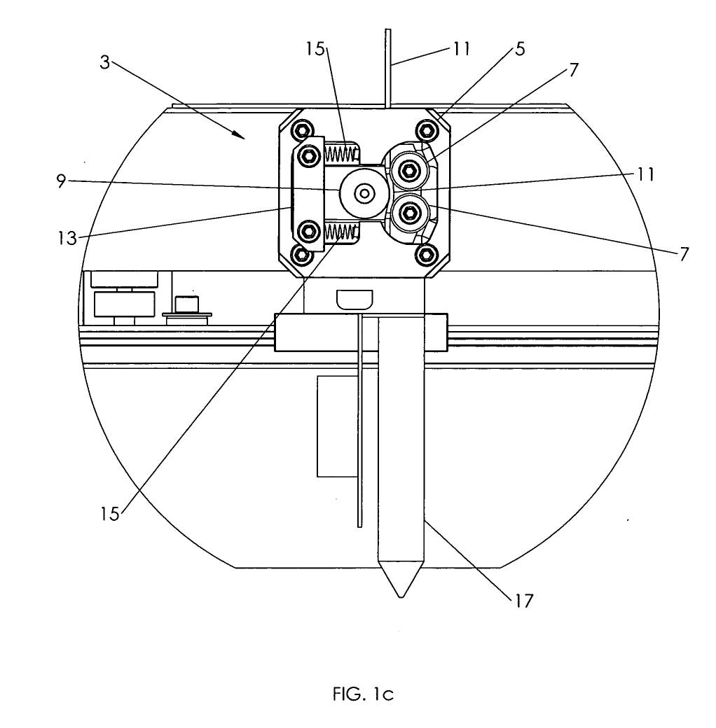

FIGS. 1a-1c show 3D printer 1. Print head assembly 3 is mounted on filament motor 5. Print head assembly 3 has twin idlers 7 to provide traction of motor drive gear 9 on filament 11. Print head assembly 3 has drive gear 9 and two idlers 7. The presence of two idlers 7 applying pressure, via clutch 13 with springs 15, onto filament 11 causes filament to bend around drive gear 9, increasing the surface contact area, and increasing the traction on filament 11 being pushed into nozzle 17.

The print head shown in these drawings may be replaced with a laser, mill or other tool.

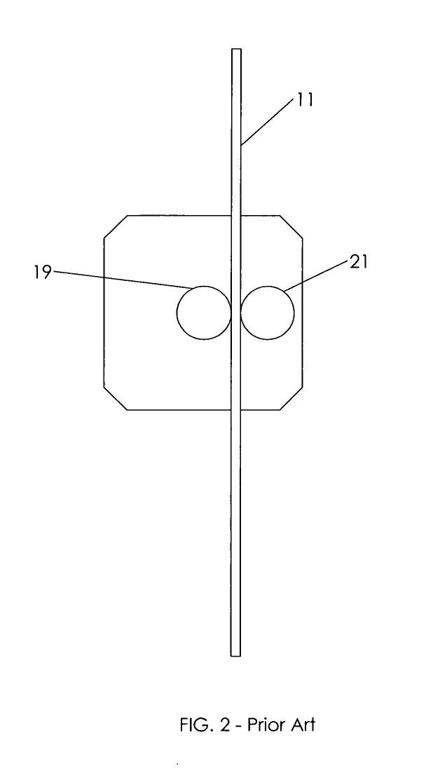

FIG. 2 shows a prior art filament motor drive gear 19 with single idler 21. The configuration relies on one tangential location of contact due to the normal force applied by the single idler 21 onto filament 11, thereby reducing the traction on filament 11 being pushed into the nozzle.

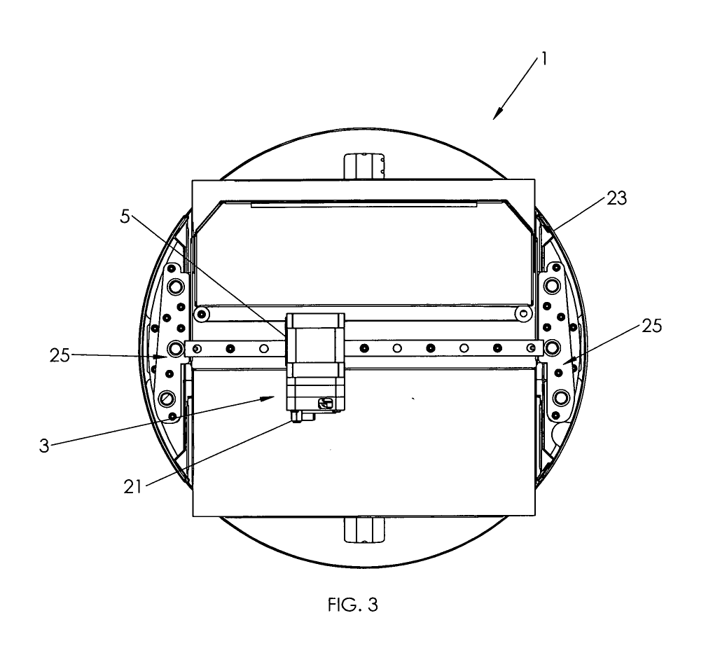

FIG. 3 is a section view from FIG. 1b. Printer head assembly 3 width is limited to the width of filament motor 5. No part of printer head assembly 3 extends beyond the vertical sides of filament motor 5. Prior art printers have not limited the width of the printer head assembly. Prior art printer head assemblies often have components that extend to the left or right of the motor—filament clutch levers and cooling fans often exceed the width motor. Clutch button 21, nor fan, nor drive idlers 7 extend beyond the motor 5 width unlike other 3D printers. By limiting the width of the printer head assembly 3 to the width of the filament motor 5, for a given width of structure 23 the range of motion of the print head assembly is maximized—there are no components that extend to hit the structure 23 or other internal components 25 and limit the range of motion. This feature increases the ratio of build area to printer footprint which is advantageous for the user who can produce bigger parts while taking up less desk space compared to the competition. Similarly the volume of the printer is minimized for a given print area which is advantageous for storage and shipping.

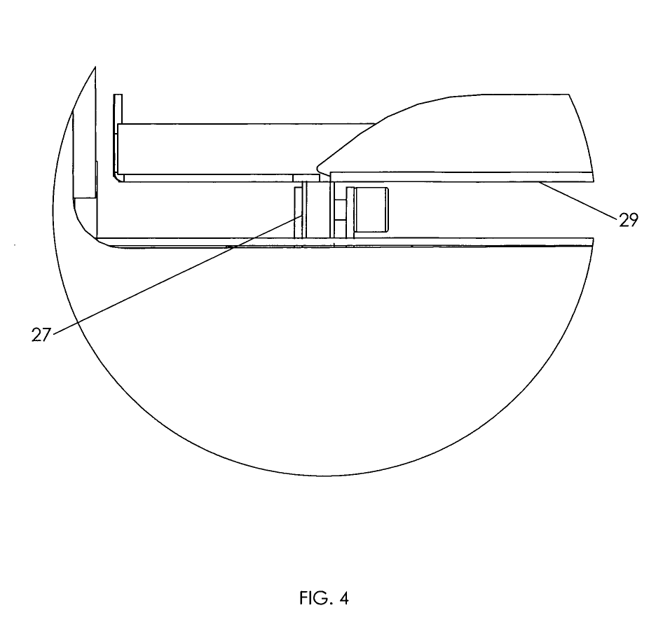

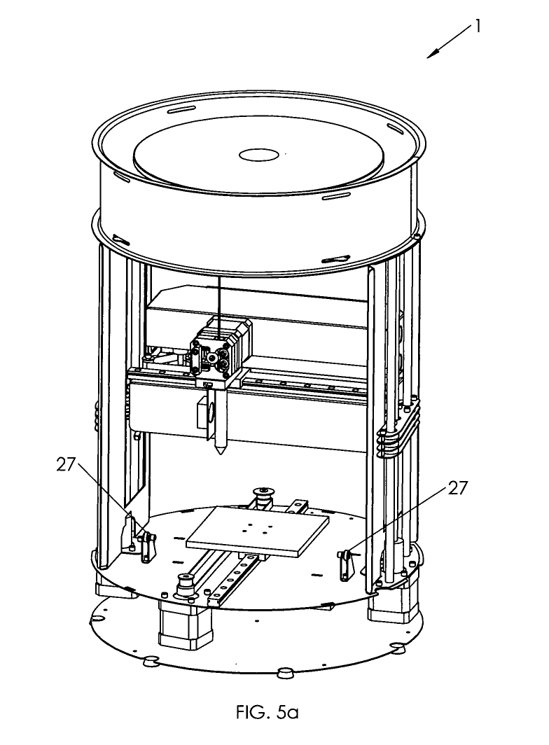

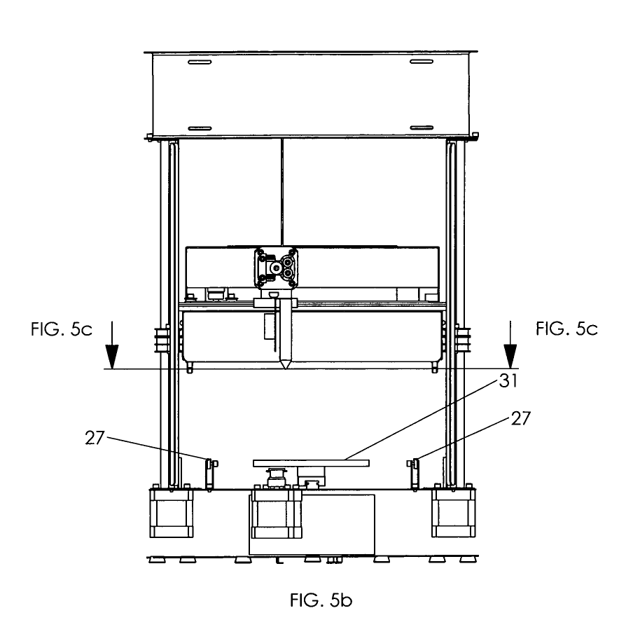

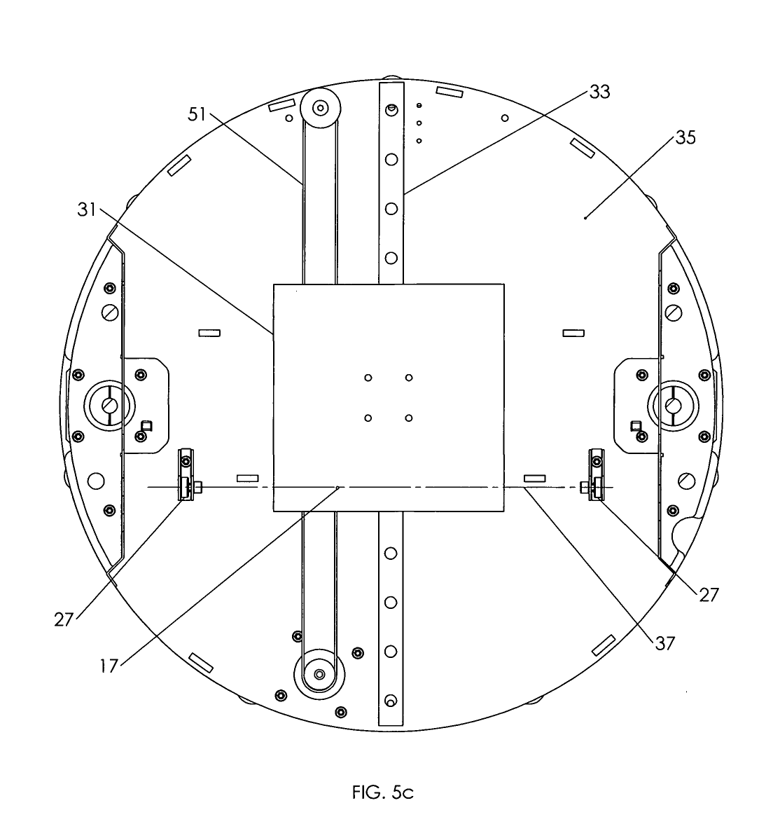

FIG. 4 is a detail view from FIG. 1b showing roller bearing 27 supporting build platform 29 at the outer extremity. FIGS. 5a-5c show 3D printer 1 and roller bearings 27 (build platform 29 and YZ axis coverplates are hidden for clarity). Build platform 29 is supported by Y rail linear bearing mounting plate 31 and two roller bearings 27, one on either side. Y rail 33 and roller bearings 27 are mounted to YZ axis assembly plate 35. Roller bearings 27 serve to reduce deflection of build platform 29 on either side of the Y rail 33. This additional support allows build platform 29 to have less structure and be lighter weight. Bearings 27 are mounted directly below the line of travel 37 of extrusion nozzle 17 where it is most important to limit deflection and produce a higher quality part.

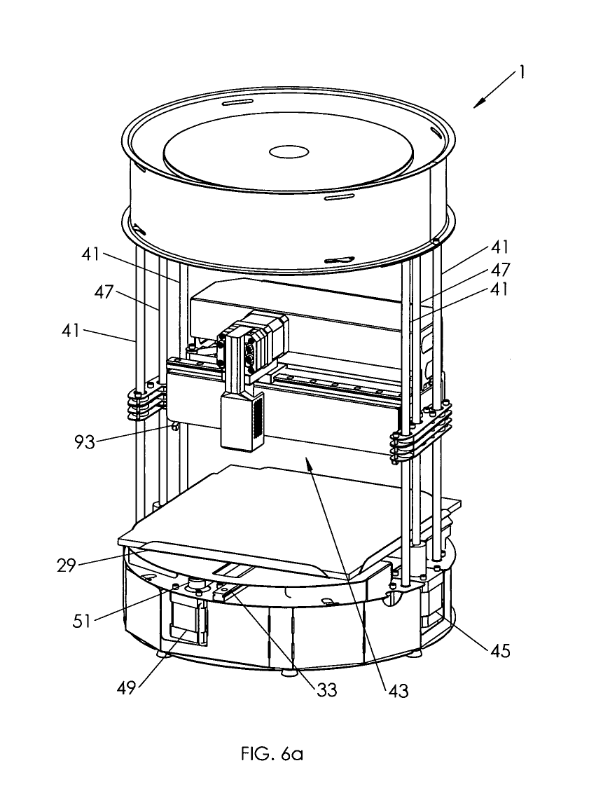

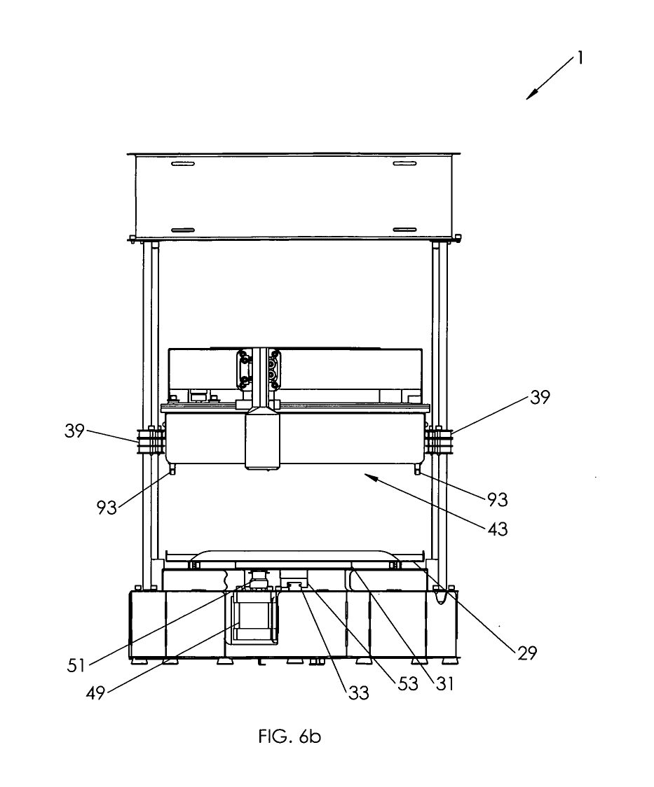

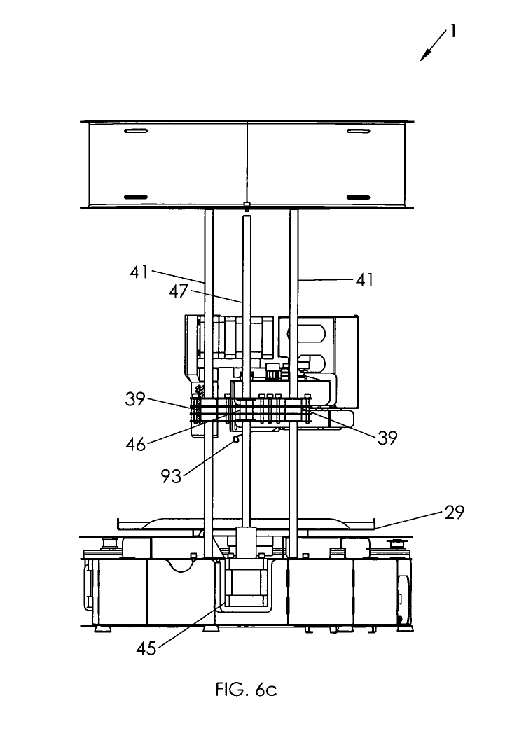

FIGS. 6a-6c show 3D printer 1 with shell housing and Z motor mount brackets removed for clarity. 3D printer 1 has four linear bearings 39 traveling on four bearing rods 41 for vertical travel of XZ axis assembly 43 including print head assembly 3. Z motors 45 drive lead screws 47 via nuts 46 and control vertical travel of the XZ axis assembly 43. Y motor 49 drives belt 51 which drives linear bearing 53, mounting plate 31 and build platform 29 riding on Y rail 33.

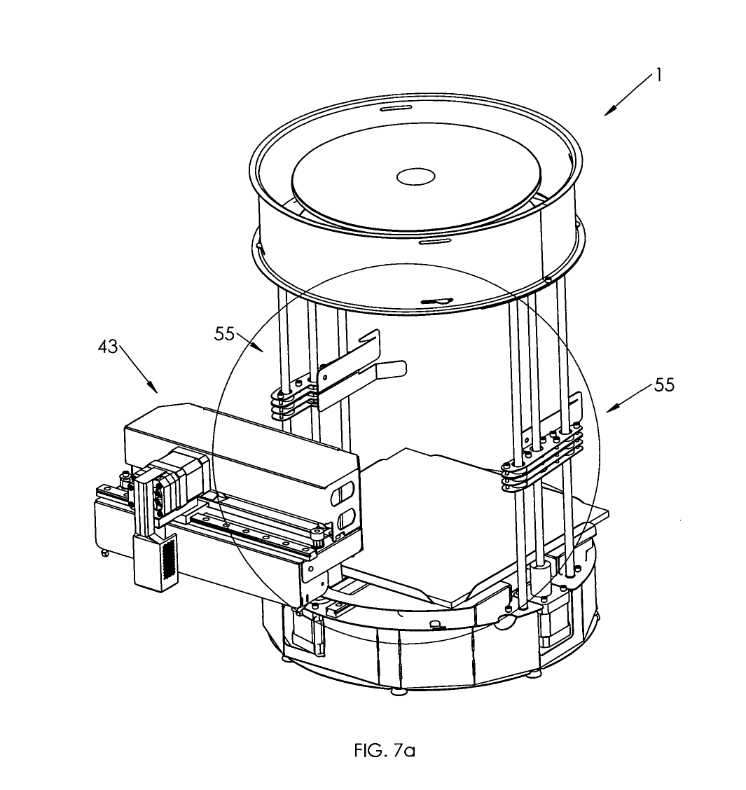

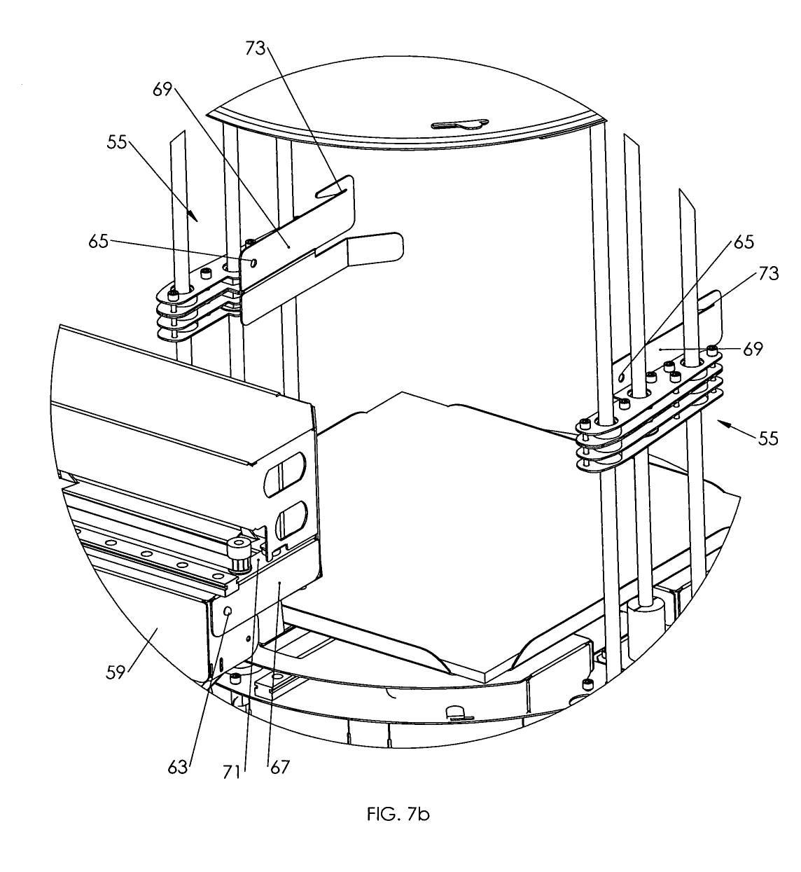

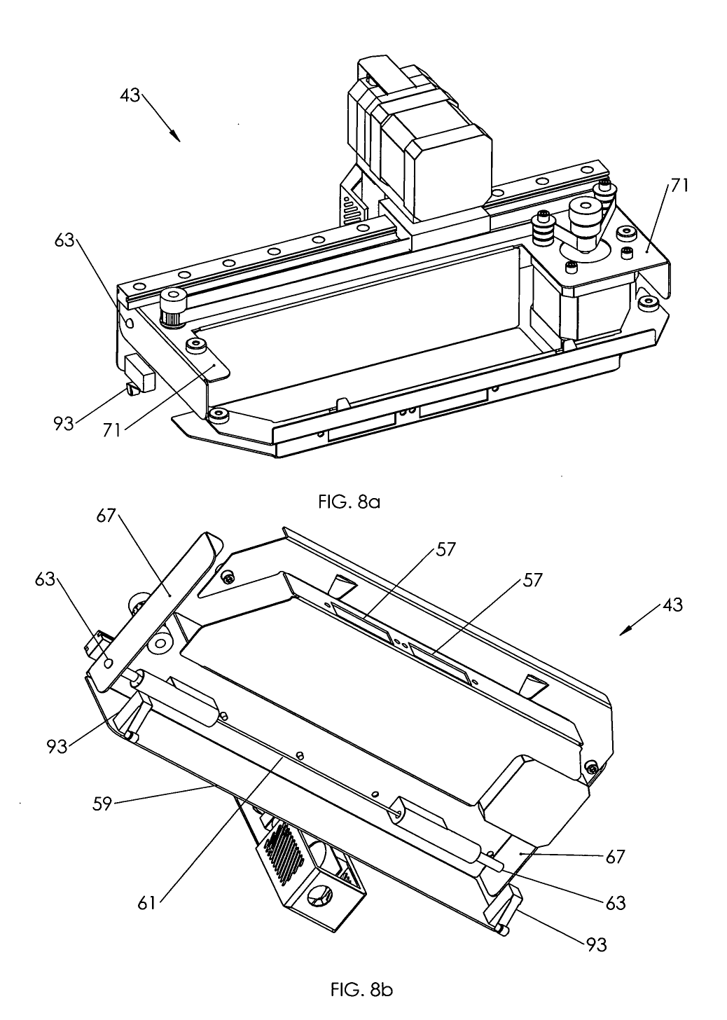

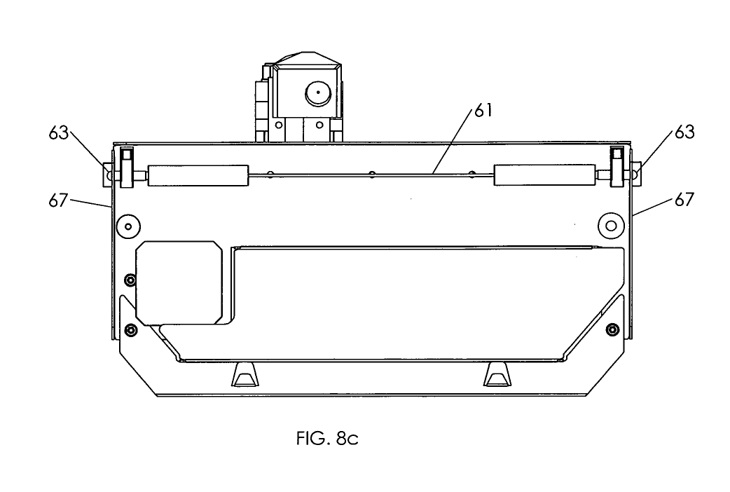

FIG. 7a-7b show 3D printer 1 with XZ axis assembly 43 disengaged from elevator brackets 55. FIGS. 8a-8c show XZ axis assembly 43 with CPU enclosure and circuit boards removed for clarity. XZ axis assembly 43 is removable from elevator brackets 55 and printer 1 without tools. First, ribbon cable (not shown) is removed from XZ axis assembly 43 ports 57. By reaching beneath XZ axis assembly plate 59 with fingers, aircraft cable actuator 61 is tensioned to release the assembly 43. Aircraft cable 61 is strung between spring loaded pins 63. By pulling aircraft cable 61, spring loaded pins 63 retract from holes 65 in plates 69 of elevator brackets 55. XZ axis assembly 43 is pulled from elevator brackets 55 and printer 1. To install XZ axis assembly 43 into elevator brackets 55, vertical lateral plates 67 of XZ axis assembly plate 59 straddle vertical plates 69 of elevator bracket 55 and horizontal plate 71 of XZ axis assembly plate 59 is inserted into slots 73 at back end of elevator brackets 55. Spring loaded pins 63 are retracted in the same manner as they were for removal. When spring loaded pins 63 lines up with holes 65 in elevator brackets 55, pins 63 are released and secure XZ axis assembly 43 to elevator brackets 55.

Slots 73 are the same height as plate 71 thickness, providing a tight fit. Plate 71 in slots 73 in conjunction with pins 63 in holes, prevent XZ axis assembly 43 from moving vertically as well as fore and aft.

Plates 67 of XZ axis assembly plate 59 extend over top of the vertical plates 69 of elevator brackets 55. The tight tolerance of the width between plates 67 in relation to the distance between the elevator bracket plates 69 prevent horizontal side to side movement.

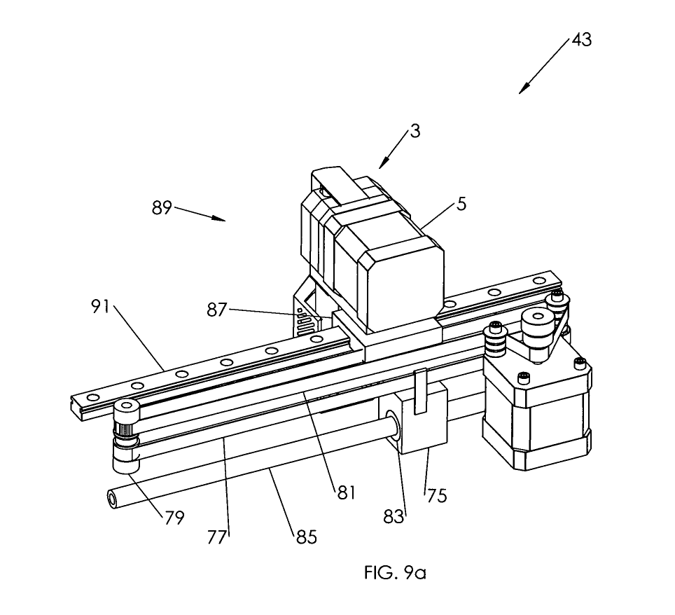

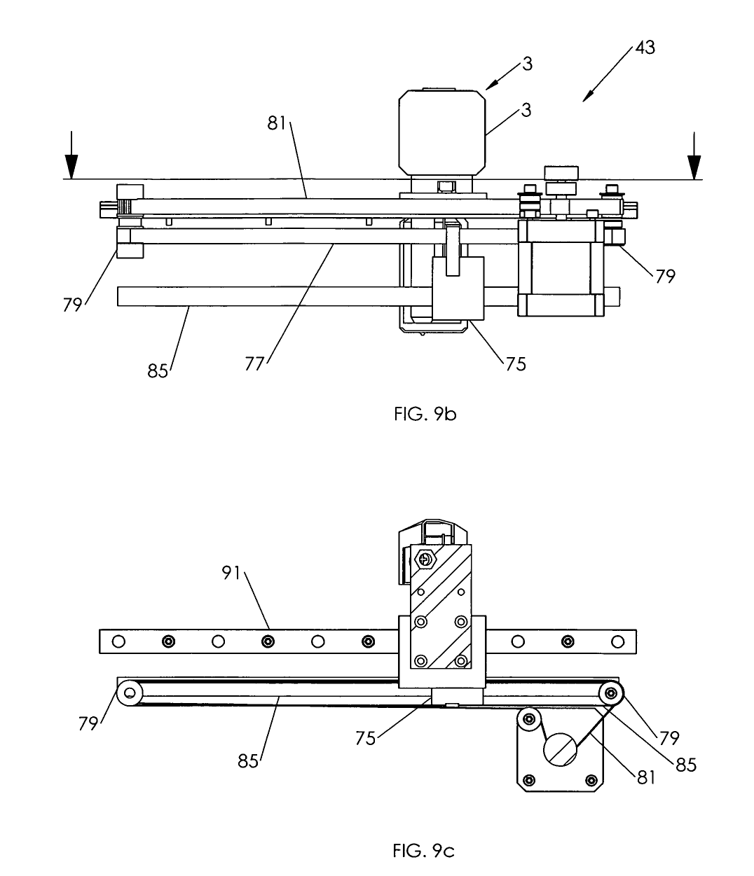

FIGS. 9a-9c show XZ axis assembly 43 with plates removed for clarity. Counterweight 75 is fixed to counterweight belt 77 which runs on idler pulleys 79 of X belt 81. Counterweight 75 is mounted on linear bearing 83 which runs on bearing rod 85. Bearing rod 85 is fixed at both ends to XZ axis assembly plate 59 (not shown). Counterweight 75 has the same (or lesser or greater) mass as filament motor assembly 89 which includes filament motor 5, linear rail bearing 87 and print head assembly 3. Counterweight 75 is on the side of the belt opposite filament motor assembly 89 so it moves in the opposite direction to that of the filament motor assembly 89 and serves to cancel (or minimize) horizontal inertia forces being transferred to the XZ axis assembly plate 59 during acceleration and deceleration of filament motor assembly 89 and minimize deflection and vibration of XZ axis assembly plate 59 and filament motor assembly 89 thus improving print quality.

X drive belt 81 is on the same plane as X rail 91 thereby reducing unwanted torque which can cause assembly deflection or vibration that can reduce print quality. If the planes are in close proximity to each other the same is true.

XZ axis assembly plate 59 has micro roller switches 93 that zero XZ axis assembly plate 59 relative to build platform 29 before each print. They extend beneath XZ axis assembly 43 in 6c, 6f, 8a and 8b. Each switch 93, when tripped, causes Z motor 45 on its respective side to stop. This ensures that both sides of XZ axis assembly 43 are at a prescribed distance from build platform 29 and that XZ axis assembly plate 59 is parallel to it and specifically due to the position of switches 93 relative to nozzle 17, nozzle 17 is zeroed and the line of travel of nozzle 17 is parallel to build platform 29. This alignment is necessary to ensure that nozzle 17 is close enough to build platform 29 to accurately lay the first layer of the part on build platform 29 but also ensuring that nozzle 17 does not collide with build platform 29.

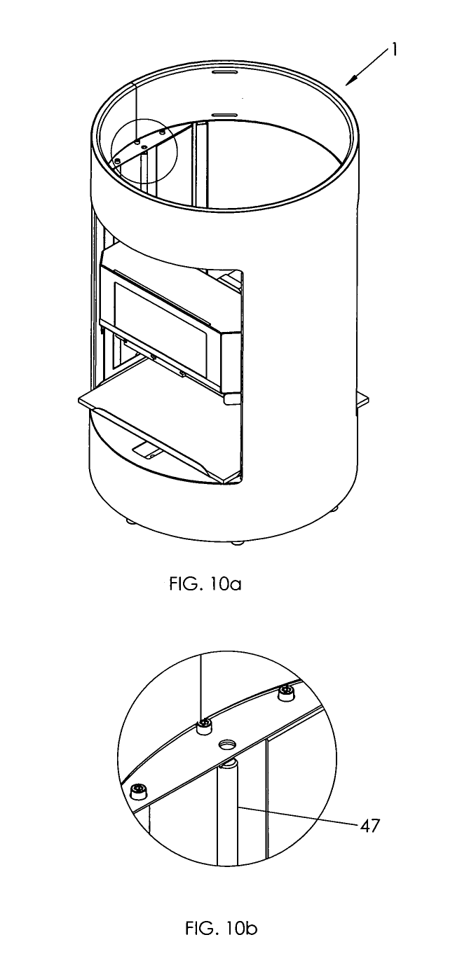

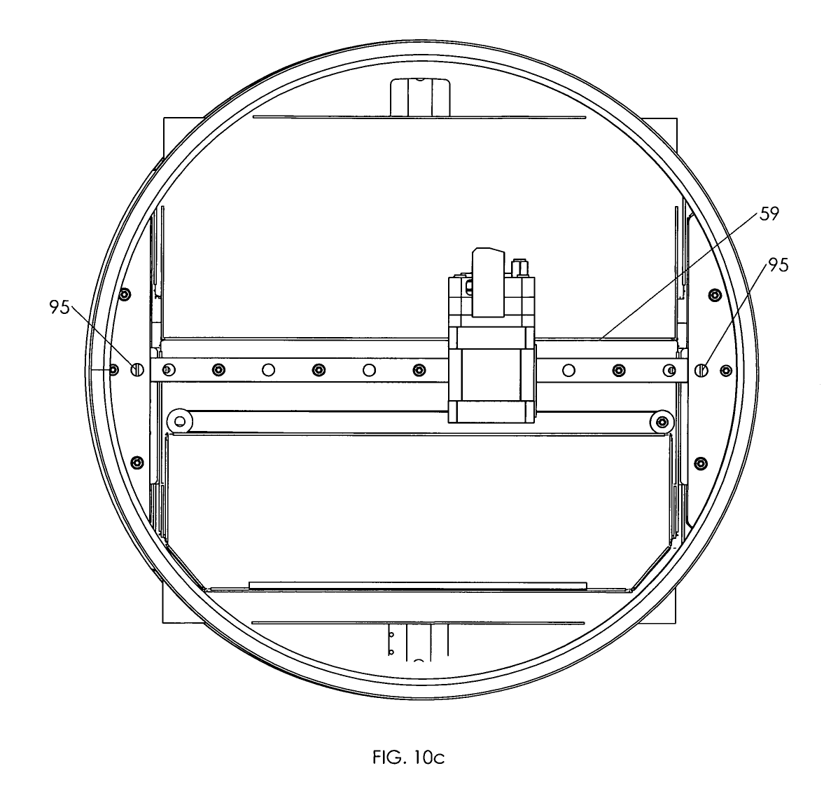

Manual zeroing of the XZ axis assembly plate 59 is also possible. FIGS. 10a-10c show 3D printer 1 with the spool and spool tray removed. The top of lead screw 47 is accessible to the user. Slot recess 95 on the top of lead screw 47 receives a flat-blade screwdriver. If for any reason manual zeroing is required, a screwdriver can be used to rotate lead screw 47 to position nozzle 17 to the correct distance from build platform 29 and align front lower edge 97 of XZ axis assembly plate 59 parallel to build platform 29.

Variations may be made to some example embodiments, which may include combinations and sub-combinations of any of the above. The various embodiments presented above are merely examples and are in no way meant to limit the scope of this disclosure. Variations of the example embodiments described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

1. A print head assembly for a three dimensional (3D) printer which uses filament, comprising:
a print head;
a motor drive to control flow of the filament through the print head; and
at least two idlers to provide traction between the motor drive gear and the filament.

2. The print head assembly as claimed in claim 1, wherein each of the idlers includes a respective clutch and one or more springs, positioned to apply pressure onto the filament to cause the filament to bend around the motor drive.

3. The print head assembly as claimed in claim 1, wherein the motor drive further comprises a motor drive gear.

4. A print head assembly for a three dimensional (3D) printer, comprising:
a print head; and
a filament motor in general axial alignment with the print head,
wherein no part of the printer head extends beyond axial widths defined by sides of the filament motor.

5. The print head assembly as claimed in claim 4 wherein a width of the print head is no greater than a corresponding width of the filament motor.

6. The print head assembly as claimed in claim 4 wherein all widths of the print head are no greater than a corresponding axial width of the filament motor.

7. A three dimensional (3D) printer and/or scanner, comprising:
a housing having an X, Y, and Z-axis;
a build platform generally in the XY axis;
a Y-axis linear rail for the build platform; and
at least one Y-axis roller bearing mounted to the housing which supports an underside of the build platform which rolls along the at least one Y-axis roller to facilitate movement in the Y-axis.

8. The 3D printer and/or scanner as claimed in claim 7, wherein the at least one roller bearing further comprises at least two roller bearings, mounted on each axial side of the Y-axis linear rail.
